(19) United States
(12) Patent Application Publication
(10) Pub. No.: US 2026/0360099 A1
(43) Pub. Date: Nov. 12, 2026

(54) INFORMATION PROCESSING SYSTEM, INFORMATION PROCESSING METHOD, AND PROGRAM

(71) Applicant: Sony Group Corporation, Tokyo (JP)

(72) Inventors: Yoichi HIROTA, Tokyo (JP); Kendai FURUKAWA, Tokyo (JP)

(73) Assignee: Sony Group Corporation, Tokyo (JP)

(21) Appl. No.: 19/629,212

(22) Filed: Mar. 26, 2026

(30) Foreign Application Priority Data
May 8, 2025 (JP) 2025-077790

(51) Int. Cl. G06T 19/20; G06T 7/20; G06T 15/08

(52) U.S. Cl. CPC G06T 19/20; G06T 7/20; G06T 15/08; G06T 2207/30196; G06T 2219/2016

(57) ABSTRACT

Provided is an information processing system that loop-reproduces, a predetermined number of times, a scene constructed by a plurality of frames generated from volumetric data. The information processing system includes a frame detection unit and an editing unit. The frame detection unit detects, as an unconstrained frame, a frame in which a motion of an object represented by the volumetric data is not constrained in a predetermined axial direction. The editing unit edits the motion represented by the object in at least the unconstrained frame among the plurality of frames so that the motion becomes another motion different from the motion.

### CROSS-REFERENCE TO RELATED APPLICATIONS

This application claims the benefit of Japanese Priority Patent Application JP 2025-077790 filed May 8, 2025, the entire contents of which are incorporated herein by reference.

### TECHNICAL FIELD

The present disclosure relates to an information processing device, an information processing method, and a program, and particularly, to an information processing device, an information processing method, and a program that improve the flexibility in editing content that is constructed by loop-reproducing a scene including volumetric images.

### BACKGROUND

A technique for generating a volumetric (free viewpoint, virtual viewpoint) image by combining images captured using a large number of cameras has been proposed.

Since a processing load related to generation of the volumetric image may be large, and there is a certain limit in generating content including scenes equal to or longer than a predetermined time, a large number of contents in which loop reproduction of a short-time scene is repeated are generated.

In the case of loop-reproducing a short-time scene, when there is a large difference between a head portion and a tail portion of the scene that forms a transition, a change in appearance is large, and a sense of discomfort is given in viewing each time the scene of the transition is repeated.

Consequently, first, two similar scenes at different timings are searched for in content including scenes of predetermined times, and short-time scenes including head portions and tail portions of the found scenes are cut out as a scene for one loop. Then, a technique has been proposed to reduce a sense of discomfort at the transitions by generating content in which the cut-out scene for one loop is loop-reproduced (see NPL 1).

### Citation List

### Patent Literature

[NPL 1] Motion Graphs for Unstructured Textured Meshes (https://hhoppe.com/proj/motiongraph/)

### SUMMARY

However, when editing is performed using content generated by the technique of NPL 1, editing in units of scenes for one loop is performed, and thus, actually possible editing is limited to editing that changes the number of loops.

The present disclosure has been made in view of such circumstances, and particularly, improves the flexibility in editing of content constructed by loop-reproducing a scene including a volumetric image (virtual viewpoint image, free viewpoint image).

An information processing device and a program according to an aspect of the present disclosure are an information processing system and a program, the information processing system loop-reproducing, a predetermined number of times, a scene constructed by a plurality of frames generated from volumetric data, the information processing system including a frame detection unit configured to detect, as an unconstrained frame, a frame in which a motion of an object represented by the volumetric data is not constrained in a predetermined axial direction, and an editing unit configured to edit the motion represented by the object in at least the unconstrained frame among the plurality of frames so that the motion becomes another motion different from the motion.

An information processing method according to an aspect of the present disclosure is an information processing method of an information processing system that loop-reproduces, a predetermined number of times, a scene constructed by a plurality of frames generated from volumetric data, the information processing method including performing a frame detection processing of detecting, as an unconstrained frame, a frame in which a motion of an object represented by the volumetric data is not constrained in a predetermined axial direction, and performing an editing processing of editing the motion represented by the object in at least the unconstrained frame among the plurality of frames so that the motion becomes another motion different from the motion.

According to an aspect of the present disclosure, a scene to be loop-reproduced a predetermined number of times is configured with a plurality of frames generated from volumetric data, a frame in which a motion of an object represented by the volumetric data is not constrained in a predetermined axial direction is detected as an unconstrained frame, and editing is performed such that a motion represented by the object in at least the unconstrained frame among the plurality of frames becomes another motion different from the motion.

### BRIEF DESCRIPTION OF DRAWINGS

FIG. 1 is a diagram illustrating content in which a short-time scene is loop-reproduced using a volumetric image.

FIG. 2 is a diagram illustrating editing of content using a volumetric image.

FIG. 3 is a diagram illustrating an overview of the present disclosure.

FIG. 4 is a diagram illustrating an example of the configuration of an information processing device to which the technology of the present disclosure is applied.

FIG. 5 is a diagram illustrating an example of the configuration of a first embodiment of a volumetric data editing unit in FIG. 4.

FIG. 6 is a diagram illustrating an example of editing the position of an object of volumetric data in a horizontal direction;

FIG. 7 is a diagram illustrating an example of editing the position of an object of volumetric data in a horizontal direction;

FIG. 8 is a diagram illustrating an example of editing the position of an object of volumetric data in a horizontal direction.

FIG. 9 is a diagram illustrating an example of editing the position of an object of volumetric data in a vertical direction.

FIG. 10 is a diagram illustrating an example of editing rotation of an object of volumetric data.

FIG. 11 is a flowchart illustrating a volumetric data editing processing by the volumetric data editing unit in FIG. 5.

FIG. 12 is a diagram illustrating editing of volumetric data using a constraint axis.

FIG. 13 is a diagram illustrating an example of the configuration of a second embodiment of a volumetric data editing unit in FIG. 12.

FIG. 14 is a flowchart illustrating a volumetric data editing processing by the volumetric data editing unit in FIG. 5.

FIG. 15 illustrates an example of the configuration of a computer.

### DESCRIPTION OF EMBODIMENTS

Preferred embodiments of the present disclosure will be described in detail below with reference to the accompanying drawings. Note that, in the present specification and the drawings, components having substantially the same functional configuration are denoted by the same reference numerals, and redundant description thereof will be omitted.

Hereinafter, embodiments for implementing the technology of the present disclosure will be described. Description will be made in the following order.
1. Overview of Present Disclosure
2. First Embodiment
3. Second Embodiment
4. Description of Computer to Which Present Technology is Applied

### 1. Overview of Present Disclosure

### Generation of Virtual Viewpoint Image

The present disclosure particularly improves the flexibility in editing of content constructed by loop-reproducing a scene including a volumetric image (virtual viewpoint image, free viewpoint image).

In describing the details of the present disclosure, an overview of the present disclosure will be described first.

As for content using a volumetric image (virtual viewpoint image, free viewpoint image), a large number of contents are generated in which a scene in a short time shorter than a predetermined time is loop-reproduced.

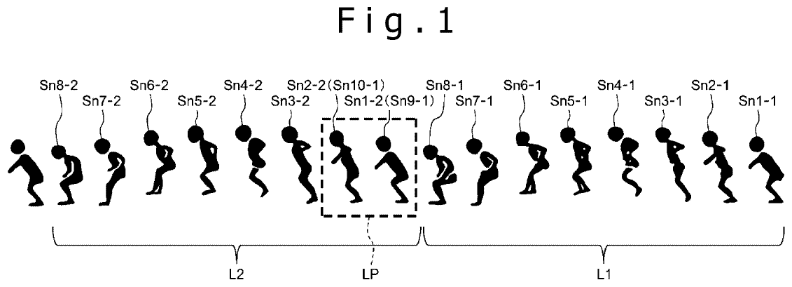

The content in which a short-time scene is repeatedly reproduced is, for example, as illustrated in FIG. 1.

FIG. 1 illustrates an example of the construction of content in which a short-time scene, representing a humanoid object represented as a volumetric image jumping from right to left in the drawing is loop-reproduced.

More specifically, in FIG. 1, a state is represented in which a humanoid object, illustrated by humanoid objects Sn1-1 to Sn8-1 from the right side in the drawing to the vicinity of the center in the drawing, jumps while changing the position and posture in time series on a per frame basis, and a first loop portion of content including one short-time scene is illustrated as a first loop part L1.

As a second loop part L2, a state is represented in which an object, illustrated by objects Sn1-2 to Sn8-2, jumps from the center to the left side in the drawing while changing the position and posture in time series on a per frame basis. Among the symbols attached to the objects, the symbols after “-” represent the number of loops, and thus the objects Sn1-1 to Sn8-1 and the objects Sn1-2 to Sn8-2 are the same. Hereinafter, in a case where it is not necessary to particularly distinguish between the two, the objects are also simply referred to as objects Sn1 to Sn8, and other constructions are also referred to in the same manner.

The content for two loops represented by the first loop part L1 and the second loop part L2 is generated by using a portion between two scenes, that is, a scene of the objects Sn1-1 and Sn2-1 and a scene of the objects Sn9-1 and Sn10-1, which are identical (or similar) to each other and have different timings, the portion being cut out from the content having a predetermined length.

The scene of the objects Sn1-1 and Sn2-1 that are the cut-out head portions and the scene of the objects Sn9-1 and Sn10-1 that are the tail portions are identical or similar to each other, and among these, the scene of the objects Sn9-1 and Sn10-1 that are the tail portions are cut off, and the scene including the objects Sn1 to Sn8 is set as a scene for one loop.

With such a configuration, at a transition LP, a head portion of the next loop including the similar objects Sn1-2 and Sn2-2 is connected to the object Sn8-1 instead of the scenes that originally include the objects Sn9-1 and Sn10-1 following the object Sn8-1, and thus a change in appearance is not noticeable at the transition, and a sense of discomfort can be reduced.

### Editing of Content Using Volumetric Image

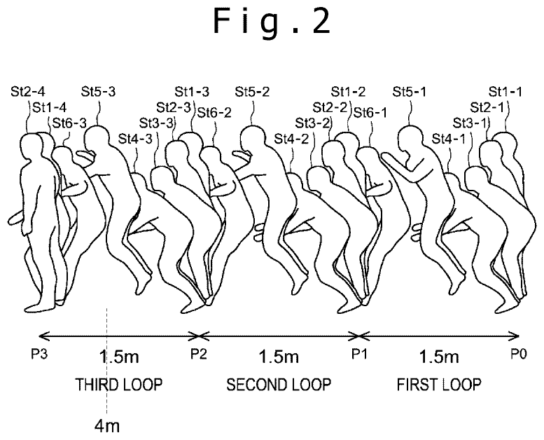

Here, as illustrated in FIG. 2, for example, content is considered in which one scene is repeated for three loops, the one scene having a predetermined time length in which a humanoid object jumps by 1.5 m.

In this case, objects St1-1 to St8-1 are set in units of frames. Thereby, when the reproduction of content is started, the objects St1-1 to St8-1 are sequentially presented on a per frame basis, and thus the object is viewed as if the object is continuously moving while changing the position and posture. As a result, in FIG. 2, as a whole, the humanoid object is visually recognized as if it has jumped from a starting point P0 to the left in the drawing and landed at a landing point P1 1.5 m ahead of the starting point P0.

Similarly, in a second loop, objects St1-2 to St8-2 are sequentially presented on a per frame basis, and thus, as a whole, the humanoid object is visually recognized as if it has further jumped from the previous landing point P1 in the left direction in the drawing and landed at the landing point P2 that is 1.5 m ahead and 3 m ahead of the starting point P0.

Similarly, in a third loop, objects St1-3 to St8-3 are sequentially presented on a per frame basis, and thus, as a whole, the humanoid object is visually recognized as if it has further jumped from the previous landing point P2 in the left direction in the drawing and landed at a landing point P3 that is 1.5 m ahead and 4.5 m ahead of the starting point P0.

When editing content as illustrated in FIG. 2, a distance of an object to be jumped can be adjusted by adjusting the number of loops of a scene of the minimum size for configuring the content.

That is, when loop reproduction is performed once, content is reproduced that represents a state in which the object jumps to the landing point P1, which is 1.5 m away from the starting point P0.

When loop reproduction is performed twice, content is reproduced that represents a state in which the object jumps to the landing point P2, which is 1.5 m away from the previous landing point P1 and 3 m away from the starting point P0.

When loop reproduction is performed three times, content is reproduced that represents a state in which the object jumps to the landing point P3 which is 1.5 m away from the previous landing point P2 and 4.5 m away from the starting point P0.

However, as illustrated in FIG. 2, a relationship between the position that can be set as the starting point P0 of the object and the position of the landing point may be always an interval of 1.5 m, and thus, for example, it may be impossible to perform editing so that the position of 4 m, which is indicated by a dashed line in the drawing, from the starting point P0 is set as a landing point.

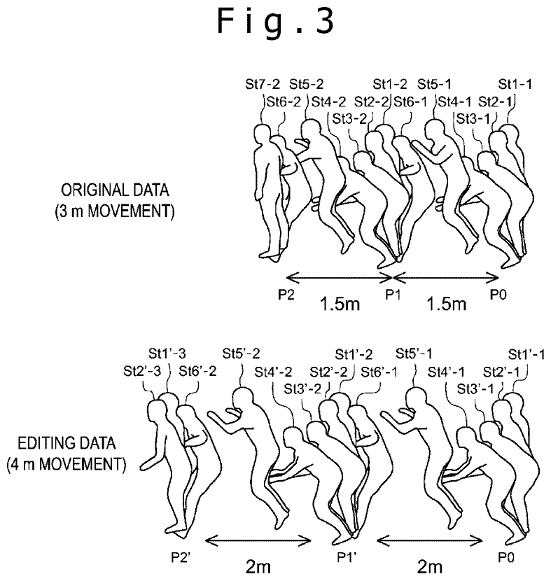

Consequently, in the present disclosure, as illustrated in FIG. 3, the content is altered and edited such that a user viewing the content does not notice the jumping distance of the object, thereby implementing editing that enables landing at an arbitrary distance.

That is, an upper part of FIG. 3 illustrates an original content similar to the content described with reference to FIG. 2, and represents a state in which the object lands at the landing point P1, which is 1.5 m away from the starting point P0, by the objects St1-1 to St6-1 in a first loop. In a second loop, a state is also represented in which the object lands at the landing point P2, which is 1.5 m further away from the previous landing point P1 and 3 m away from the starting point P0, by the objects St1-2 to St6-2.

On the other hand, a lower part of FIG. 3 represents a change in an object using content generated by editing the content in the upper part of FIG. 3 according to the present disclosure. That is, a state is represented in which the object lands at a landing point P1′, which is 2 m away from the starting point P0, by objects St1′-1 to St6′-1 in a first loop, and a state is represented in which the object lands at a landing point P2′, which is 2 m further away from the previous landing point P1′ and 4 m away from the starting point P0, by objects St1′-2 to St6′-2 in a second loop.

The objects St1′-1 to St6′-1 and St1′-2 to St6′-2 are identical to the objects St1-1 to St6-1 and St1-2 to St6-2 in the upper part of FIG. 3, except for the objects St5′-1 and St5′-1.

That is, in the lower part of FIG. 3, moving distances of the objects St5′-1 and St5′-2, which are in a state where the object is separated from the floor surface by a jump, are edited to be longer than moving distances of the original objects St5-1 and St5-2, and the moving distance of the object in one loop is set to 2 m.

For example, in a case where the object and the floor surface are in contact with each other, when the moving distance of the object is changed with respect to the original, the object is represented as if it slides on the floor surface even though the positional relationship does not change in a state where the object is in contact with the floor surface, and thus the movement is likely to be visually recognized as unnatural movement.

On the other hand, when the object and the floor surface are in a state of being separated from each other, even when the moving distance of the object is changed with respect to the original, the object and the floor surface are not in contact with each other, and thus, even when the positional relationship between the object and the floor surface is changed, the movement is hardly visually recognized as unnatural movement.

Consequently, by performing editing so as to change the moving distance at a timing at which the movement is hardly visually recognized, that is, at a timing at which the object is separated from the floor surface, it is possible to perform editing by arbitrarily changing the moving distance of the object.

Thereby, in the content in the lower part of FIG. 3, the content is reproduced that represents a state in which the object jumps to a landing point P1′, which is 2 m away from the starting point P0, in the first loop. Next, in the second loop, content is reproduced that represents a state in which the object jumps to the landing point P2′, which is 2 m away from the previous landing point P1′. That is, it is possible to edit the content so that the object is visually recognized as if it lands at the landing point P2′, which is 4 m away from the starting point P0, in the second loop.

Similarly, by performing editing so as to adjust the moving distance of the object at a timing at which the movement is hardly visually recognized, it is possible to perform editing so that an arbitrary distance becomes a landing point.

As for the timing at which the movement is hardly visually recognized, at the timing at which the object is separated from the floor surface, while not limited to editing a movement amount in the horizontal direction, editing, for example, a movement amount in the height direction may be performed, or editing a rotation amount may be performed at a timing at which the object is rotating.

As a result, according to the present disclosure, by editing a change amount (a movement amount or a rotation amount) of the object at a timing at which the movement is hardly visually recognized, it is possible to perform editing so as to set an arbitrary position or an arbitrary rotation angle, and to improve the flexibility in editing.

### 2. First Embodiment

### Example of Configuration of Hardware of Information Processing Device

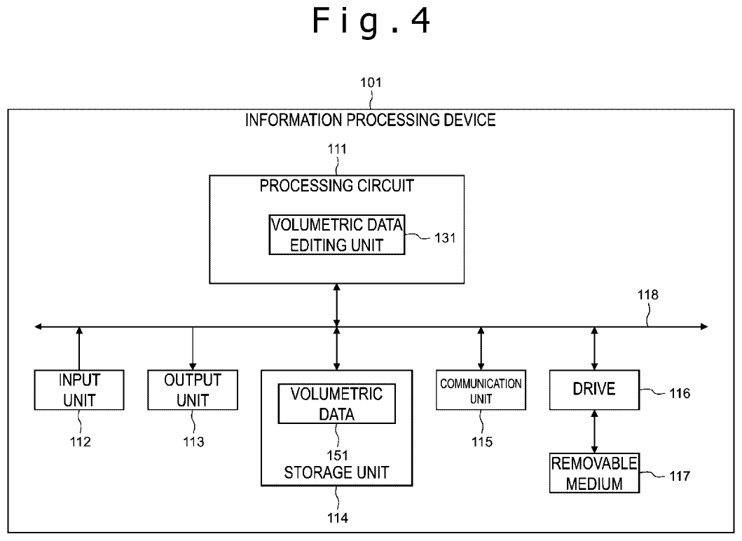

Next, an example of the configuration of hardware of an information processing device that edits content for loop-reproducing a volumetric image (virtual viewpoint image, free viewpoint image) according to the present disclosure will be described with reference to FIG. 4.

An information processing device 101 in FIG. 4 includes a processing circuit 111, an input unit 112, an output unit 113, a storage unit 114, a communication unit 115, a drive 116, and a removable medium 117, which are connected to each other via a bus 118 and can transmit and receive data and programs.

The processing circuit 111 includes a processor and a memory, and controls the overall operation of the information processing device 101. The processing circuit 111 includes a volumetric data editing unit 131.

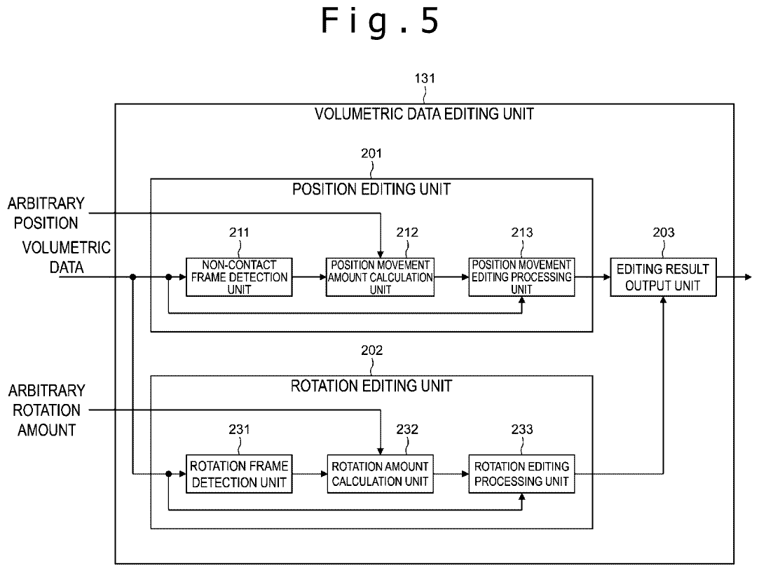

The volumetric data editing unit 131 will be described in detail later with reference to FIG. 5.

The input unit 112 includes an input device such as a keyboard, a mouse, and a touch panel for inputting various types of information, and supplies various signals corresponding to the input information to the processing circuit 111.

The output unit 113 is controlled by the processing circuit 111, and includes, for example, a display unit (not illustrated) including a display or the like that displays various processing results and input contents, and a sound output unit (not illustrated) configured with a speaker or the like that generates music, various warning sounds, and the like.

The storage unit 114 is configured with a hard disk drive (HDD), a solid state drive (SSD), or a semiconductor memory, and is controlled by the processing circuit 111 to write or read various pieces of data and programs. The storage unit 114 stores volumetric data 151 including content of a predetermined length to be loop-reproduced, which is an editing target of the volumetric data editing unit 131 of the processing circuit 111.

The communication unit 115 is controlled by the processing circuit 111, and implements wired or wireless communication represented by a local area network (LAN) or Bluetooth (registered trademark), thereby transmitting and receiving various pieces of data and programs to and from other information processing devices (not illustrated) via a network not illustrated as necessary.

The drive 116 reads and writes data from and to the removable medium 117, such as a magnetic disk (including a flexible disk), an optical disk (including a compact disc-read only memory (CD-ROM) and a digital versatile disc (DVD)), a magneto-optical disk (including a mini disc (MD)), or a semiconductor memory.

### Example of Configuration of First Embodiment of Volumetric Data Editing Unit

Next, with reference to FIG. 5, an example of the configuration of the volumetric data editing unit 131, which is a function implemented by the information processing device in FIG. 4, will be described.

The volumetric data editing unit 31 performs editing so that an object is set to be at an arbitrary position or an arbitrary rotation angle at a timing at which the movement is hardly visually recognized by the user, that is, a timing at which the object is separated from the floor surface or a timing at which the object is rotating.

More specifically, the volumetric data editing unit 131 includes a position editing unit 201, a rotation editing unit 202, and an editing result output unit 203.

The position editing unit 201 reads original volumetric data 151 and edits the position to which the original object is to be moved so that the position becomes an arbitrary target position (another arbitrary position different from the original position) that is input by the user operating the input unit 112.

More specifically, the position editing unit 201 includes a non-contact frame detection unit 211, a position movement amount calculation unit 212, and a position movement editing processing unit 213.

The non-contact frame detection unit 211 reads the original volumetric data 151, detects a frame in which the original object is in a non-contact state with an immobile object such as a floor surface, and supplies information of the detected non-contact frame to the position movement amount calculation unit 212.

The position movement amount calculation unit 212 calculates a movement amount for moving the object to a target position, further calculates a position movement amount in units of frames according to the number of frames in a non-contact state, and supplies the position movement amount to the position movement editing processing unit 213.

The position movement editing processing unit 213 performs editing so as to shift the position of an object by a position movement amount in units of frames for each frame in which the object is in a non-contact state with an immobile object such as a floor surface, based on the position movement amount in units of frames in a non-contact state supplied from the position movement amount calculation unit 212, and outputs the editing result to the editing result output unit 203.

The rotation editing unit 202 reads the original volumetric data 151 and edits a rotation angle at which the original object is rotated so that the rotation angle becomes an arbitrary target rotation angle (another arbitrary rotation angle different from the original rotation angle) that is input by the user operating the input unit 112.

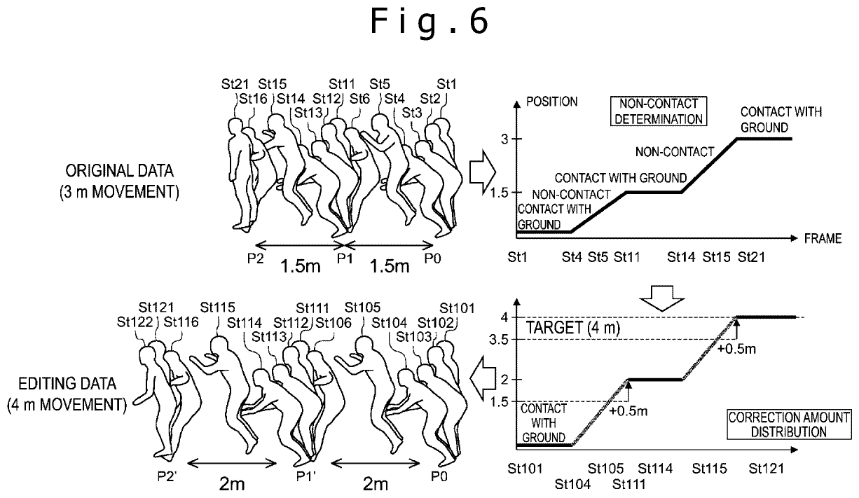

Specific processing by the position editing unit 201 will be described in detail later with reference to FIGS. 6 to 8.

The rotation editing unit 202 includes a rotation frame detection unit 231, a rotation amount calculation unit 232, and a rotation editing processing unit 233.

The rotation frame detection unit 231 reads the original volumetric data 151, detects a frame in which the original object is in a rotation state about a predetermined axis, and supplies information on the detected rotation frame to the rotation amount calculation unit 232.

The rotation amount calculation unit 232 calculates a rotation amount for adjusting the rotation angle with respect to the rotation of the original object so as to obtain a target rotation angle, calculates a rotation amount in units of frames according to the number of frames in which the object is in a rotation state, and supplies the calculated rotation amount to the rotation editing processing unit 233.

The rotation editing processing unit 233 performs editing so as to adjust the rotation of the original object by a rotation amount in units of frames for each frame in which the object is in a rotation state, based on the rotation amount in units of frames supplied from the rotation amount calculation unit 232, and outputs the editing result to the editing result output unit 203.

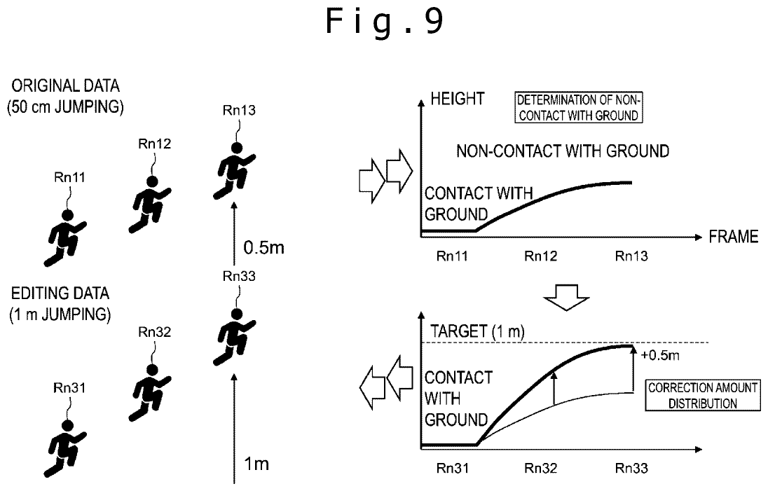

Specific processing by the rotation editing unit 202 will be described in detail later with reference to FIG. 9.

The editing result output unit 203 outputs the editing results of the position editing unit 201 and the rotation editing unit 202, and stores the editing results in the storage unit 114.

### Specific Processing of Position Editing Unit

For example, a case is considered in which the original volumetric data 151 is content, as illustrated in the upper left part of FIG. 6.

That is, the content in FIG. 6 has a configuration corresponding to that in FIG. 3, and represents a state in which the objects St1 to St6 set for each frame by a scene of a first loop jump from a starting point P0 and land at a landing point P1 separated by 1.5 m. In a second loop, a state is also represented in which the object further jumps from the previous landing point P1 and lands at a landing point P2, which is 1.5 m away from the previous landing point P1 and 3 m away from the starting point P0, by objects St11 to St16.

When a change in the position of the object of the original content in the upper left part of FIG. 6 is represented by a graph, the change is represented by a graph as illustrated in the upper right part of FIG. 6. In the upper right part of FIG. 6, the vertical axis represents a position indicating a distance from the starting point P0, and the horizontal axis represents (an object in) a frame.

That is, in a frame from the object St1 to the object St4, the position is the starting point P0, and the position is 0 because the object is in contact with the floor surface. A frame of the object St5 (a frame between the object St4 and the object St6) represents that the object is not in contact with the floor surface, and the position changes from the starting point P0 to the landing point P1 that is 1.5 m ahead of the starting point P0.

In a frame from the object St6 to the object St14, the position is the previous landing point P1, and is 1.5 m because the object is in contact with the floor surface. A frame of the object St15 (a frame between the object St14 and the object St16) represents the object not being in contact with the floor surface, and the position changing from the previous landing point P1 to a point 1.5 m ahead, that is, to the landing point P2 that is 3 m ahead of the starting point P0.

In this case, the non-contact frame detection unit 211 detects information on a frame including the objects St5 and St15 that are in a non-contact state with the floor surface, which is an immobile object, and supplies the information to the position movement amount calculation unit 212.

The position movement amount calculation unit 212 calculates a position movement amount in units of frames according to an arbitrary position that is input by the user, based on the information on the frame including the objects St5 and St15, and supplies the position movement amount to the position movement editing processing unit 213.

For example, when the target is a position that is 4 m away from the starting point P0, as illustrated in the upper left part of FIG. 6, the target is longer than 3 m of two loops of the original content and shorter than 4.5 m of three loops.

Here, when the movement of the target position from the starting point P0 to the position of 4 m is adjusted by two loops, the position movement amount calculation unit 212 calculates a difference between the target position of 4 m and 3 m, which is a moving distance of two loops by the original content, and further divides the difference by the number of loops (=2) to calculate a position movement amount for one loop as 0.5 (=1/2) m. Then, the position movement amount calculation unit 212 calculates a position movement amount of 0.5 (=0.5/1) m in units of frames by dividing the position movement amount for one loop by the number of frames in a non-contact state.

With the movement of the position to the target position 4 m away from the starting point P0 being adjusted by three loops, a difference between 4.5 m, which is a moving distance of three loops of the original content, and a target position 4 m away may be calculated, further the difference may be divided by the number of loops (=3) to calculate a position movement amount for each loop such that a moving distance is shortened by 0.33 (=1/3) m for each loop, and 0.33 (=0.33/1) m may be calculated as a movement amount in units of frames. However, in the following, an example in which adjustment is performed by two loops will be described.

The position movement editing processing unit 213 edits the frames of the objects St1 to St6 and St11 to St16 in the original content, and edits the objects to objects St101 to St106 and St111 to St116 that represent the movement from the starting point P0 to the target position of 4 m as illustrated in the lower left part of FIG. 6.

More specifically, the position movement editing processing unit 213 edits the frames of the objects St5 and St15 so that a position movement amount changes by 0.5 m in units of frames in each loop.

That is, since the objects St5 and St15 are not in contact with an immobile object such as the floor surface, even when the moving distance is changed from the original moving distance, it is difficult to visually recognize that the moving distance is changed from the comparison between the objects St5 and St15 and the floor surface.

Consequently, as illustrated in the lower right part of FIG. 6, the position movement editing processing unit 213 edits the original objects St1 to St6 of the first loop as indicated by the objects St101 to St106, and performs editing to extend the moving distance of the objects St105 so that a moving distance as a whole become a total of 2 m obtained by adding a position movement amount of 0.5 m to 1.5 m which is the original moving distance.

Similarly, as illustrated in the lower right part of FIG. 6, the position movement editing processing unit 213 edits the original objects St11 to St16 in the second loop as indicated by the objects St111 to St116, and performs editing to extend the moving distance of the object St115 so that a moving distance as a whole becomes a total of 2 m obtained by adding a position movement amount of 0.5 m to 1.5 m which is the original moving distance.

In the lower right part of FIG. 6, the moving distance of the objects St105 and St115 is obtained by adding a movement amount of 0.5 m to the original moving distance, and thus content constructed by frames including the objects St101 to St106 and the objects St111 to St116 represents that a moving distance as a whole is 2 m.

By such editing, the content is edited as illustrated in the lower left part of FIG. 6. That is, the content illustrated in the lower left part of FIG. 6 represents a state in which the object lands at a landing point P1′, which is 2 m away from the starting point P0, by the objects St101 to St106 in the first loop, and represents a state in which the object lands at a landing point P2′, which is 2 m further away from the previous landing point P1′ and 4 m away from the starting point P0, by the objects St111 to St116 in the second loop.

In this manner, the original moving distance at a timing at which the movement is hardly visually recognized, that is, a timing when the object is separated from the floor surface is edited to be changed by a position movement amount, and thus the moving distance of the object can be arbitrarily changed for editing. Thereby, it is possible to edit content such that the movement of the object represented by loop-reproducing a volumetric image (virtual viewpoint image, free viewpoint image) represents any other target motion, desired by the user, that is different from the original motion.

As a result, by performing editing so as to adjust a change amount of the object at a timing at which the movement is hardly visually recognized, it is possible to improve the flexibility in editing of content in which a volumetric image (virtual viewpoint image, free viewpoint image) is loop-reproduced.

### First Application Example of Specific Processing of Position Editing Unit

In the above, although content has been described as an example in which only a scene of one jumping is repeated for each loop, a scene of walking may be included in addition to jumping during one loop.

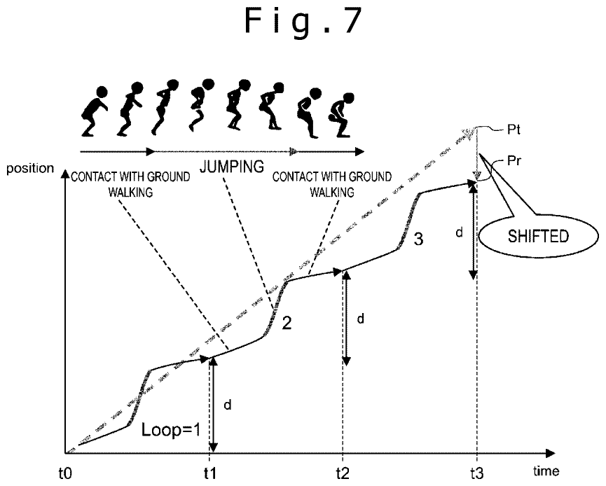

For example, as illustrated in the upper left part of FIG. 7, a case is considered in which the original content is constructed by a scene of walking in a state of being in contact with the floor surface at a predetermined speed in the first half of one loop, a next scene of jumping, and a final scene of walking in a state of being in contact with the floor surface again at a predetermined speed. Here, it is assumed that a moving distance of each of the walking, the jumping, and the walking of the object in the movement of one loop is a distance d. Further, as illustrated in the upper left part of FIG. 7, a description is given assuming that a frame including two objects is allocated to the first half of the walking scene, a frame including four objects is allocated to the jumping scene, and two frames including two objects are allocated to the last walking scene, and one loop group is configured with a total of seven frames.

In FIG. 7, it is illustrated that the time from t0 to t1 is a first loop (Loop1), the time from t1 to t2 is a second loop, the time from t2 to t3 is a third loop, and a moving distance for each loop is a distance d.

For example, as illustrated in FIG. 7, when a target position is a position at a distance Pt from the starting point and a moving distance Pr (=3×d) for three loops of the moving distance d for one loop is not a distance Pt, that is, is not a multiple of the moving distance d, even when the original content is simply loop-reproduced three times, a deviation occurs between the target position Pr and the position Pt.

Consequently, as described above, the position movement amount calculation unit 212 obtains a difference (=Pr−Pt) between the distance Pt to the target position and the moving distance Pr (=3×d) for three loops of the original moving distance, and divides the difference by 3, which is the number of loops, to calculate a position movement amount α (=(Pr−Pt)/3).

As illustrated in FIG. 7, the position movement editing processing unit 213 performs editing by adding the position movement amount α to a moving distance of an object in a jumping state that is in a non-contact state with the floor surface, among the objects in each of the original three loops, and edits the moving distance of the non-contact object so that a moving distance as a whole in each loop becomes a distance (d+α) obtained by adding the movement amount α to the original moving distance d.

More specifically, in the jumping state in which the object is in a non-contact with the floor surface as illustrated in the upper left part of FIG. 7, four objects, that is, four frames are present, and thus the position movement editing processing unit 213 edits the object of each frame by adding a position movement amount α/4 in units of frames to the original moving distance.

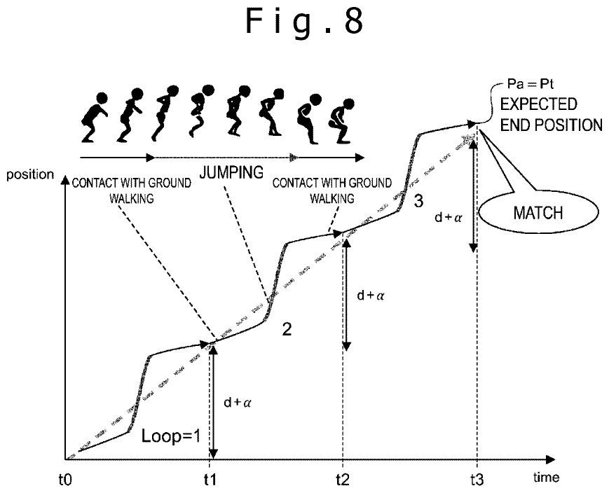

Such editing causes, as illustrated in FIG. 8, a moving distance in each loop to be a distance (d+α), and thus a moving distance in three loops becomes a distance (3d+3α). As a result, a moving distance in three loops becomes a distance Pt (=3d+3α=Pr−3×(Pr−Pt)/3) by the content after editing, and the movement to the target position is possible.

That is, in this example, editing is performed such that the moving distance is changed at a timing at which the movement is hardly visually recognized, that is, at a timing at which the object is separated from the floor surface, and thus it is possible to perform the editing while arbitrarily changing the moving distance of the object.

As a result, it is possible to improve the flexibility in editing of content in which a volumetric image (virtual viewpoint image, free viewpoint image) is loop-reproduced.

### Second Application Example of Specific Processing of Position Editing Unit

Although a description has been given above of an example in which a movement amount when a humanoid object moves in the horizontal direction is adjusted, a movement amount of the height when the humanoid object moves in the vertical direction may be adjusted.

For example, a case is considered in which the original content is a scene in which an object leaps up in the vertical direction at a predetermined speed in the first half of one loop, as illustrated in the upper left part of FIG. 9. Here, it is assumed that the moving distance of the height is 0.5 m as indicated by objects Rn11 to Rn13 in the movement of one loop.

That is, the content in FIG. 9 represents a state in which the objects Rn11 to Rn13 set for each frame by a scene for one loop jump from the floor surface and leap up (move) to the height of 0.5 m.

When a change in the height of the object of the original content in the upper left part of FIG. 9 is represented by a graph, the change is represented by a graph as illustrated in the upper right part of FIG. 9. In the upper right part of FIG. 9, the vertical axis represents a height from the floor surface, and the horizontal axis represents (an object in) a frame.

That is, it is represented that, in the frames from the objects Rn11 to Rn13, the object Rn11 is on the floor surface (is in contact with the ground), and thus the height is 0, and in the frames of the objects Rn12 and Rn13, the object is in a non-contact state with the floor surface, and the height changes to 0.5 m from the floor surface. However, since the object leaps up against the gravity, changes in the heights of the objects Rn11 to Rn13 draw a parabolic trajectory due to the action of gravity.

In this case, the non-contact frame detection unit 211 detects information on the frames including the objects Rn12 and Rn13 that are in a non-contact state with the floor surface, which is an immobile object, and supplies the information to the position movement amount calculation unit 212.

The position movement amount calculation unit 212 calculates a position movement amount in units of frames of a height corresponding to any height input by the user, based on the information on the frames including the objects Rn12 and Rn13, and supplies the calculated position movement amount to the position movement editing processing unit 213.

Here, when the movement of the position to the target height 1 m away from the floor surface is adjusted, since the height of the last object R13 of the content is the target position 1 m away, the position movement amount calculation unit 212 obtains a function equivalent to a parabola in which the height of object R13 being the last frame is 1 m following a parabolic trajectory due to the action of gravity in the original content, as illustrated in the upper right part of FIG. 9, to calculate the height of the object R12, and calculates a position movement amount in the height direction in units of frames.

The position movement editing processing unit 213 edits the frames of the respective objects Rn11 to Rn13 in the original content based on the position movement amount in the height direction in units of frames to obtain objects Rn31 to Rn33 representing that the height of the last object R13 changes to a height to the target position of 1 m, as illustrated in the lower left part of FIG. 9.

By such editing, the content is edited as illustrated in the lower left part of FIG. 9. That is, the content illustrated in the lower left part of FIG. 9 represents a state in which the objects Rn31 to Rn33 set for each frame jump up from the floor surface and leap up (move) to the height of 1 m.

In this manner, since the editing is performed such that a moving distance is changed at a timing at which the movement is hardly visually recognized, that is, at a timing at which the object is separated from the floor surface, it is possible to perform editing by arbitrarily changing the moving distance of the object.

As a result, editing is performed to adjust a change amount of the object at a timing at which the movement is hardly visually recognized, and thus it is possible to improve the flexibility in editing.

### Specific Processing of Rotation Editing Unit

For example, a case is considered in which the original volumetric data 151 is content as illustrated in the upper left part of FIG. 9.

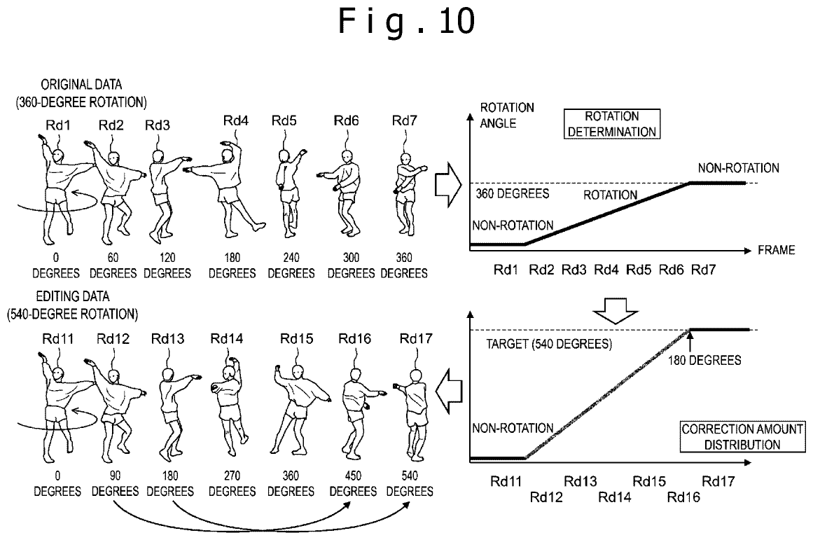

That is, the content in FIG. 10 represents a scene for one loop in which humanoid objects Rd1 to Rd7 set for each frame rotate at a rotation angle of 0 degrees to 360 degrees every 60 degrees. Regarding the rotation state of the humanoid objects in FIG. 10, the humanoid objects are not drawn to strictly match the rotation angles, but a description will be given on the assumption that the humanoid objects are rotated at set angles.

When changes in the rotation of the objects in the original content in the upper left part of FIG. 10 are represented by a graph, the changes are represented by a graph as illustrated in the upper right part of FIG. 10. In the upper right part of FIG. 10, the vertical axis represents a rotation angle, and the horizontal axis represents (an object in) each frame.

That is, it is represented that, in frames from the objects Rd1 to Rd7, the object starts rotating from a non-rotation state in which the rotation angle is 0 degrees, and the rotation angle changes by 60 degrees between the frames up to 360 degrees, leading to a non-rotation state.

In this case, the rotation frame detection unit 231 detects information on the frames including the objects Rd2 to Rd7 in a rotation state, and supplies the information to the rotation amount calculation unit 232.

The rotation amount calculation unit 232 calculates a rotation amount in units of frames according to any target rotation angle which is input by the user, based on the information on the frames including the objects Rd2 to Rd7, and supplies the rotation amount to the rotation editing processing unit 233.

For example, when the target rotation angle is 540 degrees, as illustrated in the upper left part of FIG. 10, the number of rotations is larger than 360 degrees corresponding to one loop in the original content and smaller than 720 degrees corresponding to two loops.

Here, when the rotation having a target rotation angle of 0 degrees to 360 degrees is adjusted by one loop, the rotation amount calculation unit 232 calculates a difference of 180 degrees (=540−360) between the target rotation angle of 540 degrees and 360 degrees which is the rotation angle for one loop in the original content, and further divides the difference by the number of loops (=1) to calculate 180 degrees as a rotation amount for one loop. Further, the rotation amount calculation unit 232 calculates a rotation amount of 30 (=180/6) degrees in units of frames by dividing the rotation amount of 180 degrees by 6 which is the number of frames for each of the six frames from the objects Rd2 to Rd7 in a rotation state.

As illustrated in the lower right part of FIG. 10, the rotation editing processing unit 233 edits the frames of the original objects Rd2 to Rd7 so that the rotation angle of the frames of the objects Rd11 to Rd17 as a whole becomes a total of 540 degrees obtained by adding 180 degrees, which is a rotation amount, to 360 degrees which is the original rotation angle.

More specifically, the rotation editing processing unit 233 performs editing by adding a rotation amount of 30 degrees in units of frames to a rotation angle of 60 degrees between the frames of the original objects Rd2 and Rd7, based on the rotation amount of 30 (=180/6) degrees in units of frames. As a result, as illustrated in the lower left part of FIG. 9, the objects Rd1 to Rd7 are edited such that the rotation angle in units of frames becomes 90 (=60+30) degrees, thereby generating frames including the objects Rd11 to Rd17.

That is, since the objects Rd2 to Rd7 are in a rotation state, even when the objects Rd12 to Rd17 are generated by performing editing by adding the rotation amount to the original rotation angle so as to change the rotation angle, it is difficult to visually recognize the change in the rotation amount between the frames.

As described above, since the editing is performed such that the rotation amount is changed at a timing at which the movement is hardly visually recognized, that is, at a timing at which the object is rotated, the editing can be performed by arbitrarily changing the rotation amount of the object.

As a result, it is possible to improve the flexibility in editing content in which a volumetric image (virtual viewpoint image, free viewpoint image) is loop-reproduced.

### Volumetric Data Editing Processing by Volumetric Data Editing Unit in FIG. 5

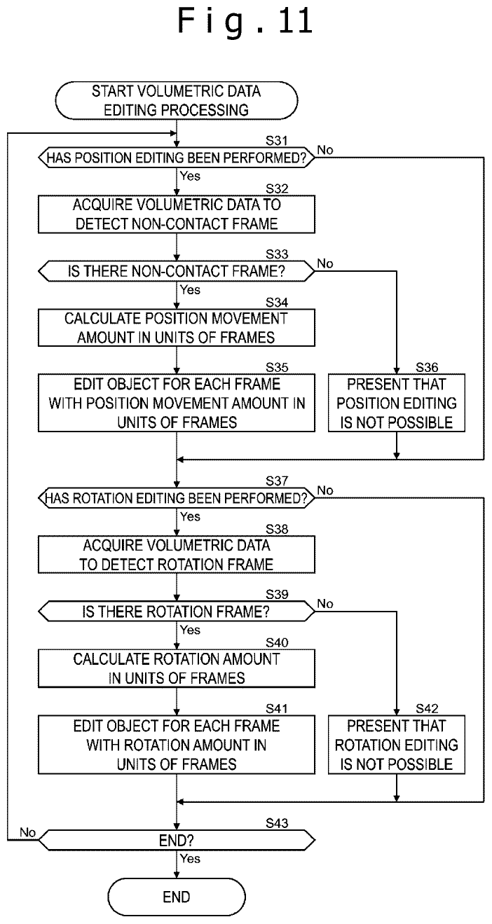

Next, a volumetric data editing processing performed by the volumetric data editing unit 131 in FIG. 5 will be described with reference to a flowchart of FIG. 11.

In step S31, the position editing unit 201 determines whether an instruction for position editing has been given when an instruction to perform editing related to a position or height for the original volumetric data 151 has been given by the user operating the input unit 112, and information on a target position and height is input.

When it is determined in step S31 that an instruction for position editing has been given, the processing proceeds to step S32.

In step S32, the non-contact frame detection unit 211 reads the original volumetric data 151, detects a frame in which the original object is in a non-contact state with an immobile object such as a floor surface, and supplies information on the detected frame to the position movement amount calculation unit 212.

In step S33, the position movement amount calculation unit 212 determines whether a frame in a non-contact state has been detected, depending on whether a frame in a non-contact state has been supplied from the non-contact frame detection unit 211.

When it is determined in step S33 that a frame in a non-contact state has been detected, the processing proceeds to step S34.

In step S34, the position movement amount calculation unit 212 calculates a position movement amount for moving the object to a target position and height, and further allocates the position movement amount according to the number of frames in which the object is in a non-contact state with the immobile object, calculates the position movement amount as a position movement amount in units of frames allocated for each frame, and supplies the position movement amount to the position movement editing processing unit 213.

In step S35, the position movement editing processing unit 213 edits the object of each frame in the original volumetric data 151 so as to reflect the position movement amount in units of frames supplied from the position movement amount calculation unit 212, and outputs content being the editing result to the editing result output unit 203. The editing result output unit 203 outputs the content being the editing result.

In step S33, when a frame in a non-contact state is not detected, the processing proceeds to step S36, and the position editing unit 201 controls the output unit 113 to present to the user that position editing is not possible.

In step S37, the rotation editing unit 202 determines whether an instruction for rotation editing has been given when an instruction to perform editing related to rotation for the original volumetric data 151 has been given by the user operating the input unit 112, and information on a target rotation angle is input.

When it is determined in step S37 that rotation editing has been instructed, the processing proceeds to step S38.

In step S38, the rotation frame detection unit 231 reads the original volumetric data 151, detects a frame in which the original object is in a rotation state, and supplies information on the detected frame to the rotation amount calculation unit 232.

In step S39, the rotation amount calculation unit 232 determines whether a frame in a rotation state has been detected, depending on whether a frame in a rotation state has been supplied from the rotation frame detection unit 231.

When it is determined in step S39 that a frame in a rotation state has been detected, the processing proceeds to step S40.

In step S40, the rotation amount calculation unit 232 calculates a rotation amount with respect to a rotation angle of the original content for rotating the object to a target rotation angle, and further allocates the rotation amount according to the number of frames in which the object is in a rotation state, calculates as a rotation amount in units of frames allocated for each frame, and supplies the rotation amount to the rotation editing processing unit 233.

In step S41, the rotation editing processing unit 233 edits the object of each frame in the original volumetric data 151 so as to reflect the rotation amount allocated in units of frames and supplied from the rotation amount calculation unit 232, and outputs content being the editing result to the editing result output unit 203. The editing result output unit 203 outputs the content as the editing result.

When a frame in a rotation state has not been detected in step S39, the processing proceeds to step S42, and the rotation editing unit 202 controls the output unit 113 to present to the user that the rotation editing is not possible.

When it is determined in step S37 that an instruction for rotation editing has not been given, steps S38 to S42 are skipped.

In step S43, when it is determined whether an instruction to end the processing has been given, and an instruction to end the processing has not been given, the processing returns to step S31, and the subsequent processing steps are repeated. That is, the processing steps of steps S31 to S43 are repeated until an instruction to end the processing is given.

When it is determined in step S43 that an instruction to end the processing has been given, the processing ends.

With the above processing, it is possible to perform editing so as to change the moving distance, the height, and the rotation angle of the object at a timing at which the movement is hardly visually recognized, that is, at a timing at which the object is separated from the floor surface or at a timing at which the object is rotating.

As a result, it is possible to improve the flexibility in editing content in which a scene of a predetermined time using a volumetric image (virtual viewpoint image, free viewpoint image) is loop-reproduced.

In the above description, an example has been described in which, in editing related to the movement of an object, the editing is performed by setting a target position with respect to the horizontal direction and the vertical direction at a timing at which the object is separated from the floor surface and obtaining a movement amount for the position, but editing may be similarly performed by obtaining a movement amount with respect to the depth direction as well.

In the above description, an example has been described in which, in editing related to the rotation of an object, the editing is performed by setting a target rotation angle with respect to a rotation direction at a timing at which the object rotates about a rotation axis set in a direction perpendicular to a floor surface, and obtaining a rotation amount with respect to the rotation angle, but the rotation axis may be not only in the direction perpendicular to the floor surface but also in the direction parallel to the floor surface, and editing may be similarly performed by obtaining a rotation amount with respect to, for example, so-called yaw, pitch, and roll directions as well.

### 3. Second Embodiment

### Constraint Axis Related to Movement in Motion of Object

A description has been given above of editing of content in which a scene of a predetermined time using a volumetric image (virtual viewpoint image, free viewpoint image) is loop-reproduced on the assumption that an object is in contact with an immobile object that does not move or is rotating.

However, regarding movement for changing a position among motions of an object, there are various variations depending on a relationship with a fixed object such as a floor surface.

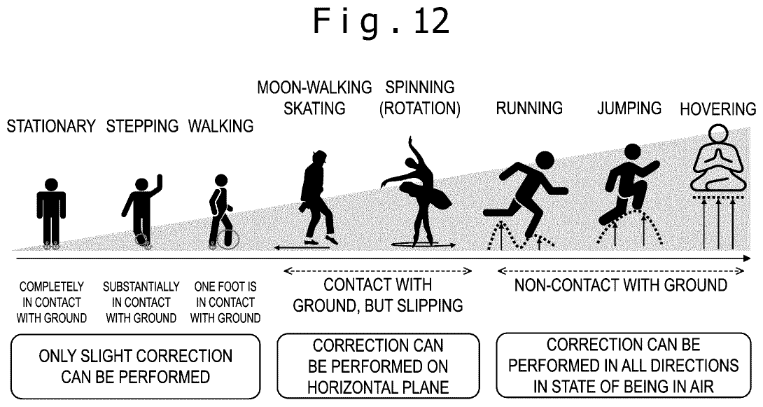

As illustrated in FIG. 12, examples thereof include, in order from the left, a stationary state, a stepping state, a walking state, a moon-walking or skating state, a spinning state, a running state, a jumping state, a hovering state, and the like on the floor surface.

Here, the stationary state is a state in which the object is completely in contact with the ground, and thus, the movement of the position in the horizontal direction and the vertical direction can be considered to be constrained.

Since the stepping state is a state in which the object is substantially in contact with the ground, the movement of the position in the horizontal direction can be considered to be completely constrained and the movement of the position in the vertical direction can be considered to be slightly changed.

Further, since the walking state is a state in which one foot is in contact with the ground, the movement of the position in the horizontal direction can be considered to be completely constrained and the movement of the position in the vertical direction can be considered to be slightly changed, as in the stepping state.

Regarding the moon-walking, skating, and spinning states, the movement of the position in the horizontal direction can be considered to be slipping, and the object can be moved freely. Thus, although the movement is not constrained, the movement of the position in the vertical direction can be considered to be constrained. The spinning state mentioned here is different from the case of the rotation described above, and is based on the assumption that the position of the rotation axis is moved while rotating.

The running, jumping, and hovering states are not constrained for the movement of the position in either the horizontal direction or the vertical direction.

From the above, the stationary state, the stepping state, the walking state, and the like can be considered to be editable because a minute change in position only slightly changes the position of the object in units of frames configuring content, and a change in appearance is small.

In the moon-walking, skating, and spinning states, the movement of the position in the vertical direction is constrained, but the movement of the position in the horizontal direction is not constrained, and thus it is possible to perform editing related to movement of the position in the horizontal direction to a target position.

In the running, jumping, and hovering states, there is no constraint on the movement of the position in the horizontal direction and the vertical direction, and thus it is possible to edit the movement in both the horizontal direction and the vertical direction to a target position.

Hereinafter, an axis in a constrained state in directions parallel and perpendicular to an object is referred to as a constraint axis, and a direction in an unconstrained state is referred to as a non-constraint axis.

Consequently, as described above, regarding the editing of a position, editing for moving the position by a slight distance that does not cause a sense of visual discomfort can be considered to be allowed for a constraint axis, and editing for moving the position by a predetermined distance that is not too large to the extent that does not cause a sense of visual discomfort can be considered to be allowed for a non-constraint axis.

Thus, it is considered that an object is edited by defining an allowable amount of editing for moving the position for each of the constraint axis and the non-constraint axis and allocating the movement amount in units of frames to a frame with the constraint axis and a frame with the non-constraint axis.

Here, a description is given of a specific example of a case where a target movement amount of the position of the object is 300 mm in the horizontal direction, for example.

In this example, it is assumed that an allowable amount of editing for moving the position of the object on the constraint axis is 0.05 (mm/frame), and an allowable amount of editing for moving the position of the object on the non-constraint axis is 5 (mm/frame). In this manner, since a relatively large movement is allowable on the non-constraint axis with respect to the allowable amount on the constraint axis on which only a minute movement amount is allowable, and thus the allowable amount is set to be sufficiently large. This is because the movement of the object on the non-constraint axis is not restricted, and the movement of the object on the constraint axis is restricted (constrained).

It is also assumed that content configured with volumetric data to be edited includes 100 frames as a whole, and among these, the number of frames of objects on the constraint axis in the horizontal direction is 30, and the number of frames of objects on the non-constraint axis in the horizontal direction is 70.

In this case, a distance that is an allowable amount of a movement amount of the position of the object as a whole based on the above-described allowable amount is calculated as in the following Formula (1).

Allowable amount of movement amount=0.05 (mm)×30 (frames)+5 (mm)×(100−30) (frames)=351.5(mm) (1)

That is, when a movement amount with respect to a target position is equal to or larger than 351.5 mm, editing is not possible. Thus, in this example in which a target movement amount is 300 mm, editing is possible.

Next, a movement amount in units of frames in 30 frames belonging to the constraint axis and a movement amount in units of frames in 70 frames belonging to the non-constraint axis are calculated as indicated in the following Formulas (2) and (3).

Movement amount in units of frames on constraint axis=(300×(1.5/351.5))/30 (frames)=0.043 (mm/frame) (2)

Movement amount in units of frames on non-constraint axis=(300×(350/351.5))/70 (frames)=4.267 (mm/frame) (3)

Based on the position movement amount in units of frames calculated as described above, the objects in 30 frames belonging to the constraint axis and the objects in 70 frames belonging to the non-constraint axis are individually edited such that the movement amount in units of frames is reflected. That is, the movement amount in units of frames on the constraint axis and the movement amount in units of frames on the non-constraint axis are calculated by a ratio of the movement amount in units of frames on the constraint axis and the movement amount in units of frames on the non-constraint axis when an allowable amount is a maximum value.

Although an example in which the constraint axis is in the horizontal direction has been described here, the same applies to a case where the constraint axis is in the vertical direction (height direction).

With the above processing, it is possible to edit the movement, which is a change in the position of an object, so as to change the position represented by a position and height by a movement amount that is difficult to be visually recognized, depending on whether the movement is on the constraint axis or on the non-constraint axis.

### Constraint Axis Related to Rotation in Motion of Object

In the above, among motions of an object, movement for changing a position has been described using the concept of a constraint axis, but the concept of the constraint axis can also be introduced for rotation among the motions of the object.

Among the motions of the object, rotation means that the front direction (any predetermined direction) of the object changes. For this reason, when there is a change in the front direction of the object, the object can be considered to be rotating, and when there is no change, the object can be considered to be not rotating.

Thus, when the front direction is considered to be the rotation directions of three axes represented by yaw, pitch, and roll directions with reference to the center position of the object, if rotation is possible in the yaw direction and rotation is not possible in the pitch and roll directions, the yaw direction can be considered to be a non-constraint axis and the pitch and roll directions can be considered to be constraint axes.

As described above, also with respect to editing of rotation, editing for changing a rotation angle by a slight rotation amount that does not cause a sense of visual discomfort can be considered to be allowed for a constraint axis, and editing for changing a rotation angle by a predetermined rotation amount that is not too large to the extent that does not cause a sense of visual discomfort can be considered to be allowed for a non-constraint axis.

Thus, it is considered that the rotation of an object is edited by defining an allowable amount of a rotation amount in the editing of a rotation angle for each of the constraint axis and the non-constraint axis, and allocating the rotation amount in units of frames to a frame with the constraint axis and a frame with the non-constraint axis.

Here, a description is given of a specific example of a case where a target rotation amount of a rotation angle of the object is 300 degrees in the horizontal direction, for example.

In this example, it is assumed that an allowable amount of editing of a rotation amount of the object on the constraint axis is 0.05 (degrees/frame), and an allowable amount of editing of a rotation amount of the object on the non-constraint axis is 5 (degrees/frame). In this manner, since a relatively large rotation is allowable on the non-constraint axis with respect to the allowable amount on the constraint axis on which only a minute rotation amount is allowable, and thus the allowable amount of the rotation amount is set to be sufficiently large. This is because the rotation of the object on the non-constraint axis (rotation axis) is not restricted, and the rotation of the object on the constraint axis is restricted (constrained).

It is also assumed that content configured with volumetric data to be edited includes 100 frames as a whole, and among these, the number of frames of objects on the constraint axis of rotation is 30, and the number of frames of objects on the non-constraint axis of rotation is 70.

In this case, a distance that is an allowable amount of a movement amount of the position of the object as a whole based on the above-described allowable amount is calculated as in the following Formula (4).

Allowable amount of rotation amount=0.05 (degrees)×30 (frames)+5 (degrees)×(100−30) (frames)=351.5(degrees) (4)

That is, when a rotation amount with respect to a target rotation angle is equal to or larger than 351.5 degrees, editing is not possible. Thus, in this example in which a target rotation angle is 300 degrees, editing is possible.

Next, a rotation amount in units of frames in 30 frames belonging to the constraint axis and a rotation amount in units of frames in 70 frames belonging to the non-constraint axis are calculated as indicated in the following Formulas (5) and (6).

Rotation amount in units of frames on constraint axis=(300×(1.5/351.5))/30 (frames)=0.043 (degrees/frame) (5)

Rotation amount in units of frames on non-constraint axis=(300×(350/351.5))/70 (frames)=4.267 (degrees/frame) (6)

Based on the rotation amount in units of frames calculated as described above, the objects in 30 frames belonging to the constraint axis and the objects in 70 frames belonging to the non-constraint axis are individually edited such that the rotation amount in units of frames is reflected. That is, the rotation amount in units of frames on the constraint axis and the rotation amount in units of frames on the non-constraint axis are calculated by a ratio of the rotation amount in units of frames on the constraint axis and the rotation amount in units of frames on the non-constraint axis when an allowable amount is a maximum value.

With the above processing, in rotation that is a change in the front direction of the object, it is possible to perform editing so as to change a rotation angle by a rotation amount that is difficult to be visually recognized in accordance with the rotation on the constraint axis and the rotation on the non-constraint axis.

### Example of Configuration of Second Embodiment of Volumetric Data Editing Unit

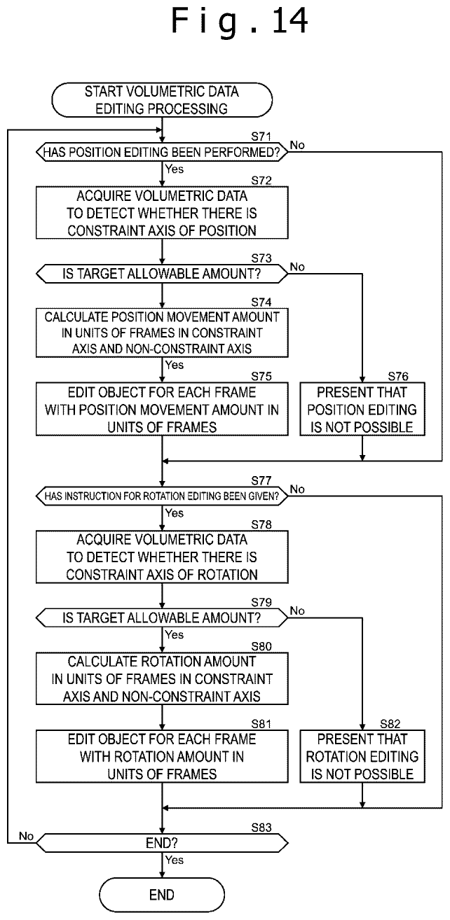

Next, an example of the configuration of a second embodiment of the volumetric data editing unit will be described with reference to FIG. 14.

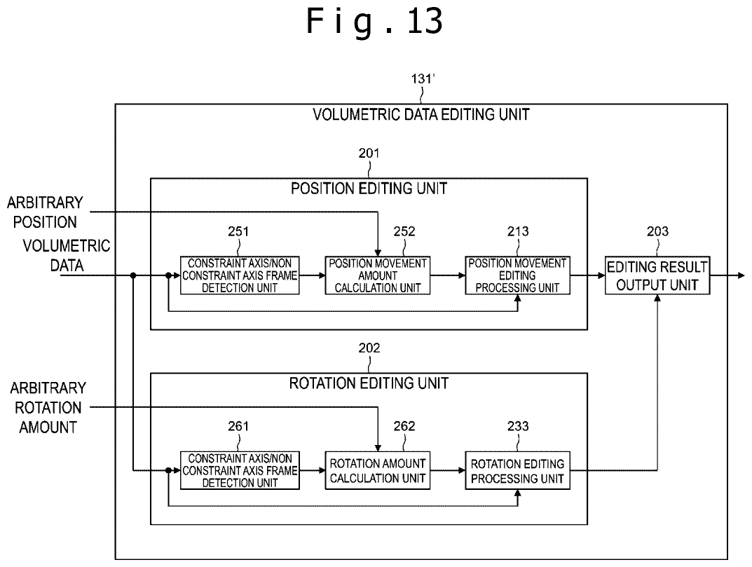

In a volumetric data editing unit 131′ in FIG. 13, components having the same functions as those of the volumetric data editing unit 131 in FIG. 5 are denoted by the same reference numerals, and the description thereof will be omitted as appropriate.

That is, a volumetric data editing unit 131′ in FIG. 13 is different from the volumetric data editing unit 131 in FIG. 5 in that a constraint axis/non-constraint axis frame detection unit 251 and a position movement amount calculation unit 252, and a constraint axis/non-constraint axis frame detection unit 261 and a rotation amount calculation unit 262 are provided instead of the non-contact frame detection unit 211 and the position movement amount calculation unit 212, and the rotation frame detection unit 231 and the rotation amount calculation unit 232.

The constraint axis/non-constraint axis frame detection unit 251 reads original volumetric data 151, detects whether movement for changing a position, among motions of an original object in units of frames, is a frame on a constraint axis or a frame on a non-constraint axis, and supplies the respective detection results to the position movement amount calculation unit 252.

The position movement amount calculation unit 252 stores an allowable amount of editing of the movement of the position of each of the frame on the constraint axis and the frame on the non-constraint axis, calculates an allowable amount as a whole as described with reference to Formula (1), and determines whether a target movement amount is within the allowable amount. When the target movement amount is within the allowable amount, the position movement amount calculation unit 252 calculates a movement amount for moving an object of each of the frame on the constraint axis and the frame on the non-constraint axis in units of frames by the calculation as indicated in the above Formula (2) and Formula (3), and supplies the calculated movement amount to the position movement editing processing unit 213.

Accordingly, the position movement editing processing unit 213 edits the objects of the frame on the constraint axis and the frame on the non-constraint axis, based on the respective movement amounts in units of frames.

The constraint axis/non-constraint axis frame detection unit 261 reads the original volumetric data 151, detects whether rotation, among the motions of the original object in units of frames, is a frame on the constraint axis or a frame on the non-constraint axis, and supplies the respective detection results to the rotation amount calculation unit 262.

The rotation amount calculation unit 262 stores an allowable amount of editing of the rotation amount of each of the frame on the constraint axis and the frame on the non-constraint axis, calculates an allowable amount as a whole as described with reference to Formula (4), and determines whether a target rotation amount is within the allowable amount. Then, when the target rotation amount is within the allowable amount, the rotation amount calculation unit 262 calculates a rotation amount for rotating an object of each of the frame on the constraint axis and the frame on the non-constraint axis in units of frames by the calculation as indicated in the above Formula (5) and Formula (6), and supplies the calculated rotation amount to the rotation editing processing unit 233.

Accordingly, the rotation editing processing unit 233 edits the objects of the frame on the constraint axis and the frame on the non-constraint axis, based on the respective rotation amounts in units of frames.

### Volumetric Data Editing Processing by Volumetric Data Editing Unit in FIG. 13

Next, a volumetric data editing processing by the volumetric data editing unit 131′ in FIG. 13 will be described with reference to a flowchart in FIG. 14.

In step S71, the position editing unit 201 determines whether an instruction for position editing has been given when an instruction to perform editing related to a position and height for the original volumetric data 151 has been given by the user operating the input unit 112, and a target position and height are input.

When it is determined in step S71 that an instruction for position editing has been given, the processing proceeds to step S72.

In step S72, the constraint axis/non-constraint axis frame detection unit 251 reads the original volumetric data 151, detects a frame existing on the constraint axis and a frame existing on the non-constraint axis for the movement of the original object, and supplies the detection result to the position movement amount calculation unit 212.

In step S73, the position movement amount calculation unit 252 calculates an allowable amount as a whole of a movement amount for moving the object to the target position by the calculation as indicated in the above Formula (1), and determines whether the allowable amount is exceeded in comparison with the movement amount for the target position.

When it is determined in step S73 that the movement amount for the target position or height does not exceed the allowable amount, the processing proceeds to step S74.

In step S74, the position movement amount calculation unit 252 calculates, in units of frames, a position movement amount for moving the object to the target position for each of the frame in which the object is present on the constraint axis and the frame in which the object is present on the non-constraint axis by the calculation as indicated in the above Formulas (2) and (3), and supplies the position movement amount to the position movement editing processing unit 213.

In step S75, the position movement editing processing unit 213 edits the object of each frame of the original volumetric data 151 so as to reflect the position movement amount allocated in units of frames and supplied from the position movement amount calculation unit 252, and outputs content being the editing result to the editing result output unit 203. The editing result output unit 203 outputs the content being the editing result.

In step S73, when the target movement amount exceeds the allowable amount, the processing proceeds to step S76, and the position editing unit 201 controls the output unit 113 to present that the position editing is not possible.

In step S77, the rotation editing unit 202 determines whether an instruction for rotation editing has been given when an instruction to perform editing related to rotation for the original volumetric data 151 has been given by the user operating the input unit 112, and information on a target rotation angle is input.

When it is determined in step S77 that rotation editing has been instructed, the processing proceeds to step S78.

In step S78, the constraint axis/non-constraint axis frame detection unit 261 reads the original volumetric data 151, detects a frame existing on the constraint axis and a frame existing on the non-constraint axis for the rotation of the original object, and supplies the detection results to the rotation amount calculation unit 262.

In step S79, the rotation amount calculation unit 262 calculates an allowable amount as a whole of a rotation amount for rotating the object to the target rotation angle by the calculation as indicated in the above Formula (4), and determines whether the allowable amount is exceeded in comparison with the rotation amount for the target rotation angle.

When it is determined in step S79 that the rotation amount for the target rotation angle does not exceed the allowable amount, then the processing proceeds to step S80.

In step S80, the rotation amount calculation unit 262 calculates, in units of frames, a rotation amount for rotating the object to the target rotation angle for each of the frame in which the object is present on the constraint axis and the frame in which the object is present on the non-constraint axis by the calculation as indicated in the above Formulas (5) and (6), and supplies the rotation amount to the rotation editing processing unit 233.

In step S81, the rotation editing processing unit 233 edits the object of each frame of the original volumetric data 151 so as to reflect the rotation amount allocated in units of frames and supplied from the rotation amount calculation unit 262, and outputs content being the editing result to the editing result output unit 203. The editing result output unit 203 outputs the content being the editing result.

In step S79, when the target rotation amount exceeds the allowable amount, the processing proceeds to step S82, and the rotation editing unit 202 controls the output unit 113 to present that the rotation editing is not possible.

Also in the above processing, the position of an object based on a minute position movement amount is edited for a frame in which an object is present on a constraint axis related to movement, and thus it is possible to perform editing that is hardly visually recognized. The position of an object based on a position movement amount that does not cause a sense of visual discomfort is edited for a frame in which an object is present on a non-constraint axis related to movement, and thus it is possible to perform editing that is hardly visually recognized.

The rotation of an object based on a minute rotation amount is edited for a frame in which an object is present on a constraint axis related to rotation, and thus it is possible to perform editing that is hardly visually recognized. The position of an object based on a rotation amount that does not cause a sense of visual discomfort is edited for a frame in which an object is present on a non-constraint axis related to rotation, and thus it is possible to perform editing that is hardly visually recognized.

As a result, it is possible to improve the flexibility in editing content for loop-reproducing a scene of a predetermined time using a volumetric image (virtual viewpoint image, free viewpoint image).

In the above description, the processing is based on a state in which an object is constrained on a constraint axis and a state in which an object is not constrained on a constraint axis, but a constraint range which is a range in which an object is constrained may be set on the constraint axis, and an allowable amount may be set to change depending on the constraint range.

That is, for example, when a floor surface is on a constraint axis in the vertical direction, an allowable amount in a constrained state in which an object is not separated from the floor surface can be set to only a small allowable amount with respect to a target height in the vertical direction, but in the case of a constraint range up to approximately several centimeters from the floor surface, an allowable amount of the position movement amount in the height direction may be set to increase as the constraint range increases.

In the above description, an example has been described in which an allowable amount of a movement amount or a rotation amount is set to a small value for an object on a constraint axis whose movement direction or rotation direction is constrained, and an allowable amount of a movement amount or a rotation amount is set to a relatively large value for an object on a non-constraint axis whose movement direction or rotation direction is not constrained.

In the first embodiment, an object in a non-contact state with the floor surface is a part of the object on the non-constraint axis with respect to the movement direction in the second embodiment, and in the first embodiment, an object in a rotation state is a part of the object on the non-constraint axis with respect to the rotation direction in the second embodiment.

That is, in the first embodiment, the position, height, and rotation angle of an object on a non-constraint axis are edited. On the other hand, in the second embodiment, it can be considered that editing of the position, height, rotation angle, and the like is realized for an object on a constraint axis in addition to an object on a non-constraint axis while making it difficult to visually recognize the editing.

### 4. Description of Computer to Which Present Technology is Applied

The above-described series of processing steps can be executed by hardware or software. When the series of processing operations is executed by the software, a program constituting the software is installed on a computer. Here, the computer includes a computer embedded in dedicated hardware, and, for example, a general-purpose personal computer that can execute various functions by installing various programs.

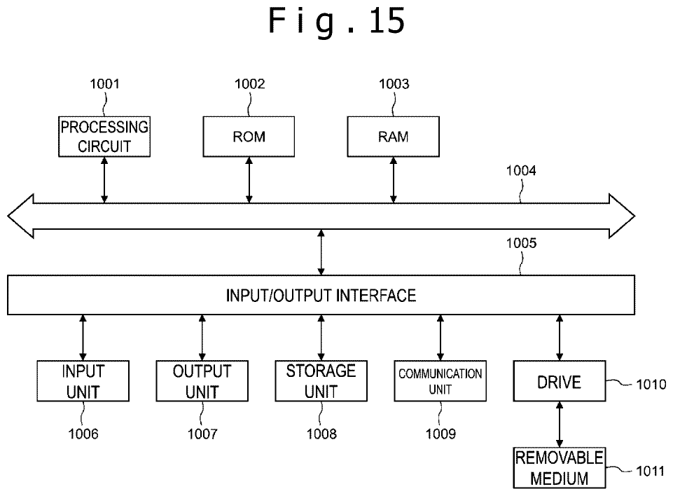

FIG. 15 is a block diagram illustrating an example of the configuration of hardware of a computer that executes the above-described series of processes by a program.

In the computer, a processing circuit 1001, a read only memory (ROM) 1002, and a random access memory (RAM) 1003 are connected to one another via a bus 1004.

An input/output interface 1005 is also connected to the bus 1004. The input/output interface 1005 is connected to an input unit 1006, an output unit 1007, a storage unit 1008, a communication unit 1009, and a drive 1010.

The input unit 1006 may include a physical or virtual operation means for inputting information by a user's operation, such as a keyboard, a mouse, or a touch panel, and a means for inputting information by a user by using voices, lines of sight, or the like. Further, the input unit 1006 can include sensors for inputting various physical quantities to the computer. For example, the input unit 1006 can include sensors that acquire physical quantities of light (including infrared rays other than visible light), sound, or the like, such as a camera or a microphone. In addition, for example, the input unit 1006 can include sensors that acquire other physical quantities such as temperature, moisture content, acceleration, and distance. The output unit 1007 can include a means for presenting information to the user by stimulating the user's perception, such as a display, a speaker, or a haptic device. The storage unit 1008 includes a hard disk, a nonvolatile or volatile memory, or the like, and stores various types of information (including programs). The communication unit 1009 is a network interface or the like, and performs wired or wireless communication with the outside. The drive 1010 drives a removable medium 1011 such as a magnetic disk, an optical disc, a magneto-optical disc, or a semiconductor memory.

The processing circuit 1001 includes a processor that executes a program, such as a central processing unit (CPU) or a digital signal processor (DSP). The (processor of the) processing circuit 1001 loads the program stored in the storage unit 1008 into the RAM 1003 via the input/output interface 1005 and the bus 1004, and executes the program, thereby performing the above-mentioned series of processing operations. The processing circuit 1001 can cause the output unit 1007 to output the processing result of the series of processes, for example, via the bus 1004 and the input/output interface 1005, as necessary. The processing circuit 1001 can also cause the storage unit 1008 to store the processing result, cause the communication unit 1009 to transmit the processing result, and the like.

The program executed by the computer (processing circuit 1001) can be provided by being recorded in the removable medium 1011 as a package medium or the like, for example. Further, the program can be provided via a wired or wireless transmission medium, such as a local area network, the Internet, or digital satellite broadcasting.

In the computer, the program can be installed in the storage unit 1008 via the input/output interface 1005 by mounting the removable medium 1011 in the drive 1010. The program can also be received through the communication unit 1009 from another apparatus such as a server via a wired or wireless transmission medium and installed in the storage unit 1008. In addition, the program can be pre-installed in the ROM 1002 or the storage unit 1008.

The program executed by the computer may be a program in which processing is performed in a time-series manner in the order described in the present specification, or may be a program in which processing is performed in parallel or at a necessary timing such as a time when a call is made.

The processing performed by the computer according to the program does not have to be performed in time series in the order described as the flowchart. That is, the processing performed by the computer according to the program includes processing executed in parallel or in an individual manner (for example, parallel processing or processing by an object).

The program may be processed by one computer (processor) or may be processed in a distributed manner by a plurality of computers. Further, the program may be transferred to a remote computer and executed.

When the series of processing operations described above is performed by the computer executing the program, the processing circuit 1001 (the processor thereof) functions as the volumetric data editing unit 131 of FIG. 5 and the volumetric data editing unit 131 of FIG. 13 by executing the program.

In the present specification, the system means one component or a set of a plurality of components (apparatuses, modules (parts), and the like). Thus, one or a plurality of components of a computer, for example, only a processor or a combination of a processor and a memory, for example, only the processing circuit 1001 or a combination of the processing circuit 1001 to the bus 1004 is a system. With respect to a set of a plurality of components, it does not matter whether all the components are in the same housing or not. Therefore, the system refers to both a plurality of devices housed in separate housings and connected via a network, and one device in which a plurality of modules are housed in one housing. Furthermore, for example, the entire computer, or a combination of a computer and another device such as a server not illustrated is also a system.

In addition, for example, each step of one flowchart can be performed by one device or by multiple devices in a distributed manner. Further, when a single step includes multiple processing operations, the multiple processing operations may be performed by a single device or may be performed by multiple devices in a distributed manner. In other words, the plurality of processing operations included in one step can be executed as processing operations of a plurality of steps. Conversely, the processing operations described as a plurality of steps can collectively be executed as one step.

In addition, for example, the program executed by a computer may be configured such that the processing operations of the steps describing the program are performed in time series in the order described in the present description, performed in parallel, or in an individual manner at necessary timing such as when being called. That is, the processing of each step may be executed in an order different from the above-described order as long as no contradiction occurs. Further, the processing operations of the steps describing the program may be executed in parallel with the processing operations of another program or may be executed in combination with the processing operations of another program.

For example, a plurality of technologies related to the present disclosure can each be implemented independently in a single component as long as no contradiction occurs. Of course, any of the plurality of the present technologies can also be implemented in combination. For example, a part or all of the present technologies described in any of the embodiments can be implemented in combination with a part or all of the present technologies described in another embodiment. A part or all of any of the present disclosure described above can be implemented in combination with another technology that is not described above.

The present disclosure may also be configured as follows.

<1> An information processing system that loop-reproduces, a predetermined number of times, a scene constructed by a plurality of frames generated from volumetric data, the information processing system including:
a frame detection unit configured to detect, as an unconstrained frame, a frame in which a motion of an object represented by the volumetric data is not constrained in a predetermined axial direction; and
an editing unit configured to edit the motion represented by the object in at least the unconstrained frame among the plurality of frames so that the motion becomes another motion different from the motion.

<2> The information processing system according to <1> , wherein
the frame detection unit detects, among the plurality of frames, the unconstrained frame in which movement of a position is not constrained in the predetermined axial direction, the movement being included in the motions of the object represented by the plurality of frames, and
the editing unit edits the position of the object in at least the unconstrained frame among the plurality of frames to another position different from the position for representing the other motion.

<3> The information processing system according to <2> , further including
a position movement amount calculation unit configured to calculate a position movement amount that is a difference between the position of the object in the unconstrained frame and the other position, and calculate a position movement amount of the unconstrained frame in units of frames, based on the number of unconstrained frames,
wherein the editing unit moves and edits the position of the object of each of the unconstrained frames based on the position movement amount of the unconstrained frame in units of frames.

<4> The information processing system according to <3> , wherein
the frame detection unit further detects, as a constrained frame, a frame in which movement of the position of the object is constrained with respect to the predetermined axial direction, among the plurality of frames,
the position movement amount calculation unit calculates a position movement amount of the position of the object in the unconstrained frame in units of frames and a position movement amount of the position of the object in the constrained frame in units of frames, and
the editing unit edits the position of the object in each of the unconstrained frames, based on the position movement amount of the unconstrained frame in units of frames, and edits the position of the object in each of the constrained frames, based on the position movement amount of the constrained frame in units of frames.

<5> The information processing system according to <4> , wherein
the position movement amount of the unconstrained frame in units of frames and the position movement amount of the constrained frame in units of frames are obtained as a ratio of a value, which is obtained by multiplying an allowable amount of the position movement amount of the unconstrained frame in units of frames by the number of unconstrained frames among all of the plurality of frames, and a value, which is obtained by multiplying an allowable amount of the position movement amount of the constrained frame in units of frames by the number of constrained frames among all the frames.

<6> The information processing system according to <1> , wherein the unconstrained frame is a frame in which the object is not in contact with an immobile object.

<7> The information processing system according to <1> , wherein
the frame detection unit detects, as an unconstrained frame, a frame in which rotation is not constrained with respect to the predetermined axial direction, the rotation being included in the motions of the object represented by the plurality of frames, among the plurality of frames, and
the editing unit edits a rotation angle of the object in at least the unconstrained frame among the plurality of frames to another rotation angle different from the rotation angle for representing the other motion.

<8> The information processing system according to <7> , further including
a rotation amount calculation unit configured to calculate a rotation amount that is a difference between the rotation angle of the object in the unconstrained frame and the other rotation angle, and calculate a rotation amount of the unconstrained frame in units of frames based on the number of unconstrained frames,
wherein the editing unit edits the rotation angle of the object in each of the unconstrained frames based on the rotation amount of the unconstrained frame in units of frames.

<9> The information processing system according to <8> , wherein
the frame detection unit further detects, as a constrained frame, a frame in which the object is constrained with respect to rotation in the predetermined axial direction among the plurality of frames,
the rotation amount calculation unit calculates a rotation amount of the rotation angle of the object in units of frames in the unconstrained frame and a rotation amount of the position of the object in units of frames in the constrained frame, and
the editing unit edits the rotation angle of the object in each of the unconstrained frames based on the rotation amount of the unconstrained frame in units of frames, and edits the rotation angle of the object in each of the constrained frames based on the rotation amount of the constrained frame in units of frames.

<10> The information processing system according to <9> , wherein
the rotation amount of the unconstrained frame in units of frames and the rotation amount of the constrained frame in units of frames are at a ratio of a value, which is obtained by multiplying an allowable amount of the rotation amount of the unconstrained frame in units of frames by the number of unconstrained frames, to a value, which is obtained by multiplying an allowable amount of the rotation amount of the constrained frame in units of frames by the number of constrained frames.

<11> The information processing system according to <1> , wherein the unconstrained frame is a frame in which the object is rotating.

<12> An information processing method of an information processing system that loop-reproduces, a predetermined number of times, a scene constructed by a plurality of frames generated from volumetric data, the information processing method including:
performing a frame detection processing of detecting, as an unconstrained frame, a frame in which a motion of an object represented by the volumetric data is not constrained in a predetermined axial direction; and
performing an editing processing of editing the motion represented by the object in at least the unconstrained frame, among the plurality of frames, so that the motion becomes another motion different from the motion.

<13> The information processing method according to <12> , wherein the frame detection processing includes detecting, as an unconstrained frame, a frame in which movement of a position is not constrained in the predetermined axial direction, among the plurality of frames, the movement being included in the motions of the object represented by the plurality of frames, and
the editing processing includes editing the position of the object in at least the unconstrained frame among the plurality of frames to another position different from the position for representing the other motion.

<14> The information processing method according to <13> , further including performing a position movement amount calculation processing of calculating a position movement amount that is a difference between the position of the object in the unconstrained frame and the other position, and calculating a position movement amount of the unconstrained frame in units of frames, based on the number of unconstrained frames,
wherein the editing processing includes moving and editing the position of the object of each of the unconstrained frames based on the position movement amount of the unconstrained frame in units of frames.

<15> The information processing method according to <14> , wherein
the frame detection processing further includes detecting, as a constrained frame, a frame in which movement of the position of the object is constrained with respect to the predetermined axial direction, among the plurality of frames,
the position movement amount calculation processing includes calculating a position movement amount of the position of the object in units of frames in the unconstrained frame and a position movement amount of the position of the object in units of frames in the constrained frame, and
the editing processing includes editing the position of the object in each of the unconstrained frames, based on the position movement amount of the unconstrained frame in units of frames, and editing the position of the object in each of the constrained frames, based on the position movement amount of the constrained frame in units of frames.

<16> The information processing method according to <12> , wherein
the frame detection processing includes detecting, as an unconstrained frame, a frame in which rotation is not constrained with respect to the predetermined axial direction, among the plurality of frames, the rotation being included in the motions of the object represented by the plurality of frames, and
the editing processing includes editing a rotation angle of the object in at least the unconstrained frame among the plurality of frames to another rotation angle different from the rotation angle for representing the other motion.

<17> The information processing method according to <16> , further including performing a rotation amount calculation processing of calculating a rotation amount that is a difference between the rotation angle of the object in the unconstrained frame and the other rotation angle, and calculating a rotation amount of the unconstrained frame in units of frames, based on the number of unconstrained frames,
wherein the editing processing includes editing the rotation angle of the object in each of the unconstrained frames, based on the rotation amount of the unconstrained frame in units of frames.

<18> The information processing method according to <17> , wherein
the frame detection processing further includes detecting, as a constrained frame, a frame in which the object is constrained with respect to rotation in the predetermined axial direction among the plurality of frames,
the rotation amount calculation processing includes calculating a rotation amount of the rotation angle of the object in units of frames in the unconstrained frame and a rotation amount of the position of the object in units of frames in the constrained frame, and
the editing processing includes editing the rotation angle of the object in each of the unconstrained frames, based on the rotation amount of the unconstrained frame in units of frames, and editing the rotation angle of the object in each of the constrained frames, based on the rotation amount of the constrained frame in units of frames.

<19> The information processing method according to <18> , wherein
the rotation amount of the unconstrained frame in units of frames and the rotation amount of the constrained frame in units of frames are at a ratio of a value, which is obtained by multiplying an allowable amount of the rotation amount of the unconstrained frame in units of frames by the number of unconstrained frames, to a value, which is obtained by multiplying an allowable amount of the rotation amount of the constrained frame in units of frames by the number of constrained frames.

<20> A program causing a computer configuring an information processing system that loop-reproduces, a predetermined number of times, a scene constructed by a plurality of frames generated from volumetric data to function as:
a frame detection unit configured to detect, as an unconstrained frame, a frame in which a motion of an object represented by the volumetric data is not constrained in a predetermined axial direction; and
an editing unit configured to edit the motion represented by the object in at least the unconstrained frame among the plurality of frames, so that the motion becomes another motion different from the motion.

It should be understood by those skilled in the art that various modifications, combinations, sub-combinations and alterations may occur depending on design requirements and other factors insofar as they are within the scope of the appended claims or the equivalents thereof.

### REFERENCE SIGNS LIST

101 Information processing device, 131 Volumetric data editing unit, 201 Position editing unit, 202 Rotation editing unit, 203 Editing result output unit, 211 Non-contact frame detection unit, 212 Position movement amount calculation unit, 213 Position movement editing processing unit, 231 Rotation frame detection unit, 232 Rotation amount calculation unit, 233 Rotation editing processing unit, 251 Constraint axis/non-constraint axis frame detection unit, 252 Position movement amount calculation unit

1. An information processing system that loop-reproduces, a predetermined number of times, a scene constructed by a plurality of frames generated from volumetric data, the information processing system comprising:
a frame detection unit configured to detect, as an unconstrained frame, a frame in which a motion of an object represented by the volumetric data is not constrained in a predetermined axial direction; and
an editing unit configured to edit the motion represented by the object in at least the unconstrained frame among the plurality of frames so that the motion becomes another motion different from the motion.

2. The information processing system according to claim 1, wherein
the frame detection unit detects, among the plurality of frames, the unconstrained frame in which movement of a position is not constrained in the predetermined axial direction, the movement being included in the motions of the object represented by the plurality of frames, and
the editing unit edits the position of the object in at least the unconstrained frame among the plurality of frames to another position different from the position for representing the other motion.

3. The information processing system according to claim 2, further comprising a position movement amount calculation unit configured to calculate a position movement amount that is a difference between the position of the object in the unconstrained frame and the other position, and calculate a position movement amount of the unconstrained frame in units of frames, based on the number of unconstrained frames,
wherein the editing unit moves and edits the position of the object of each of the unconstrained frames, based on the position movement amount of the unconstrained frame in units of frames.

4. The information processing system according to claim 3, wherein
the frame detection unit further detects, as a constrained frame, a frame in which movement of the position of the object is constrained with respect to the predetermined axial direction, among the plurality of frames,
the position movement amount calculation unit calculates a position movement amount of the position of the object in the unconstrained frame in units of frames and a position movement amount of the position of the object in the constrained frame in units of frames, and
the editing unit edits the position of the object in each of the unconstrained frames, based on the position movement amount of the unconstrained frame in units of frames, and edits the position of the object in each of the constrained frames, based on the position movement amount of the constrained frame in units of frames.

5. The information processing system according to claim 4, wherein
the position movement amount of the unconstrained frame in units of frames and the position movement amount of the constrained frame in units of frames are obtained as a ratio of a value, which is obtained by multiplying an allowable amount of the position movement amount of the unconstrained frame in units of frames by the number of unconstrained frames among all of the plurality of frames, to a value, which is obtained by multiplying an allowable amount of the position movement amount of the constrained frame in units of frames by the number of constrained frames among all the frames.

6. The information processing system according to claim 1, wherein the unconstrained frame is a frame in which the object is not in contact with an immobile object.

7. The information processing system according to claim 1, wherein
the frame detection unit detects, as an unconstrained frame, a frame in which rotation is not constrained with respect to the predetermined axial direction, the rotation being included in the motions of the object represented by the plurality of frames, among the plurality of frames, and
the editing unit edits a rotation angle of the object in at least the unconstrained frame among the plurality of frames to another rotation angle different from the rotation angle for representing the other motion.

8. The information processing system according to claim 7, further comprising a rotation amount calculation unit configured to calculate a rotation amount that is a difference between the rotation angle of the object in the unconstrained frame and the other rotation angle, and calculate a rotation amount of the unconstrained frame in units of frames based on the number of unconstrained frames,
wherein the editing unit edits the rotation angle of the object in each of the unconstrained frames based on the rotation amount of the unconstrained frame in units of frames.

9. The information processing system according to claim 8, wherein
the frame detection unit further detects, as a constrained frame, a frame in which the object is constrained with respect to rotation in the predetermined axial direction, among the plurality of frames,
the rotation amount calculation unit calculates a rotation amount of the rotation angle of the object in units of frames in the unconstrained frame and a rotation amount of the position of the object in units of frames in the constrained frame, and
the editing unit edits the rotation angle of the object in each of the unconstrained frames based on the rotation amount of the unconstrained frame in units of frames, and edits the rotation angle of the object in each of the constrained frames based on the rotation amount of the constrained frame in units of frames.

10. The information processing system according to claim 9, wherein
the rotation amount of the unconstrained frame in units of frames and the rotation amount of the constrained frame in units of frames are at a ratio of a value, which is obtained by multiplying an allowable amount of the rotation amount of the unconstrained frame in units of frames by the number of unconstrained frames, to a value, which is obtained by multiplying an allowable amount of the rotation amount of the constrained frame in units of frames by the number of constrained frames.

11. The information processing system according to claim 1, wherein the unconstrained frame is a frame in which the object is rotating.

12. An information processing method of an information processing system that loop-reproduces, a predetermined number of times, a scene constructed by a plurality of frames generated from volumetric data, the information processing method comprising:
performing a frame detection processing of detecting, as an unconstrained frame, a frame in which a motion of an object represented by the volumetric data is not constrained in a predetermined axial direction; and
performing an editing processing of editing the motion represented by the object in at least the unconstrained frame, among the plurality of frames, so that the motion becomes another motion different from the motion.

13. The information processing method according to claim 12, wherein
the frame detection processing includes detecting, as an unconstrained frame, a frame in which movement of a position is not constrained in the predetermined axial direction, among the plurality of frames, the movement being included in the motions of the object represented by the plurality of frames, and
the editing processing includes editing the position of the object in at least the unconstrained frame among the plurality of frames to another position different from the position for representing the other motion.

14. The information processing method according to claim 13, further comprising performing a position movement amount calculation processing of calculating a position movement amount that is a difference between the position of the object in the unconstrained frame and the other position, and calculating a position movement amount of the unconstrained frame in units of frames, based on the number of unconstrained frames,
wherein the editing processing includes moving and editing the position of the object of each of the unconstrained frames based on the position movement amount of the unconstrained frame in units of frames.

15. The information processing method according to claim 14, wherein
the frame detection processing further includes detecting, as a constrained frame, a frame in which movement of the position of the object is constrained with respect to the predetermined axial direction, among the plurality of frames,
the position movement amount calculation processing includes calculating a position movement amount of the position of the object in units of frames in the unconstrained frame and a position movement amount of the position of the object in units of frames in the constrained frame, and
the editing processing includes editing the position of the object in each of the unconstrained frames, based on the position movement amount of the unconstrained frame in units of frames, and editing the position of the object in each of the constrained frames, based on the position movement amount of the constrained frame in units of frames.

16. The information processing method according to claim 12, wherein
the frame detection processing includes detecting, as an unconstrained frame, a frame in which rotation is not constrained with respect to the predetermined axial direction, among the plurality of frames, the rotation being included in the motions of the object represented by the plurality of frames, and
the editing processing includes editing a rotation angle of the object in at least the unconstrained frame among the plurality of frames to another rotation angle different from the rotation angle for representing the other motion.

17. The information processing method according to claim 16, further comprising performing a rotation amount calculation processing of calculating a rotation amount that is a difference between the rotation angle of the object in the unconstrained frame and the other rotation angle, and calculating a rotation amount of the unconstrained frame in units of frames, based on the number of unconstrained frames,
wherein the editing processing includes editing the rotation angle of the object in each of the unconstrained frames, based on the rotation amount of the unconstrained frame in units of frames.

18. The information processing method according to claim 17, wherein
the frame detection processing further includes detecting, as a constrained frame, a frame in which the object is constrained with respect to rotation in the predetermined axial direction, among the plurality of frames,
the rotation amount calculation processing includes calculating a rotation amount of the rotation angle of the object in units of frames in the unconstrained frame and a rotation amount of the position of the object in units of frames in the constrained frame, and
the editing processing includes editing the rotation angle of the object in each of the unconstrained frames, based on the rotation amount of the unconstrained frame in units of frames, and editing the rotation angle of the object in each of the constrained frames, based on the rotation amount of the constrained frame in units of frames.

19. The information processing method according to claim 18, wherein
the rotation amount of the unconstrained frame in units of frames and the rotation amount of the constrained frame in units of frames are at a ratio of a value, which is obtained by multiplying an allowable amount of the rotation amount of the unconstrained frame in units of frames by the number of unconstrained frames, to a value, which is obtained by multiplying an allowable amount of the rotation amount of the constrained frame in units of frames by the number of constrained frames.

20. A program causing a computer configuring an information processing system that loop-reproduces, a predetermined number of times, a scene constructed by a plurality of frames generated from volumetric data to function as:
a frame detection unit configured to detect, as an unconstrained frame, a frame in which a motion of an object represented by the volumetric data is not constrained in a predetermined axial direction; and
an editing unit configured to edit the motion represented by the object in at least the unconstrained frame among the plurality of frames, so that the motion becomes another motion different from the motion.
